(19) United States
(12) Patent Application Publication
(10) Pub. No.: US 2018/0187543 A1
(43) Pub. Date: Jul. 5, 2018

(54) DISTRIBUTED ELECTROMOTIVE FORCE SENSING

(71) Applicant: Halliburton Energy Services, Inc., Houston, TX (US)

(72) Inventors: Glenn Andrew Wilson, Singapore (SG); Tasneem A. Mandviwala, Katy, TX (US); Ahmed Elsayed Fouda, Houston, TX (US); Burkay Donderici, Houston, TX (US); Etienne M. Samson, Cypress, TX (US)

(73) Assignee: Halliburton Energy Services, Inc., Houston, TX (US)

(21) Appl. No.: 15/740,299

(22) PCT Filed: Jul. 27, 2015
(86) PCT No.: PCT/US2015/042252

§ 371 Date: Dec. 27, 2017

(51) Int. Cl. E21B 47/10; E21B 47/12; E21B 47/06

(52) U.S. Cl. CPC E21B 47/102; G01F 1/6847; E21B 47/06; E21B 47/123

(57) ABSTRACT

Systems and methods for formation evaluation and reservoir monitoring that use electromotive force measurements. A well monitoring system may comprise: a power supply that generates an electromagnetic field in a subterranean formation; and a distributed electromotive force sensor for measuring electromotive force at one or more points along a length of the distributed electromotive sensor, wherein the distributed electromotive force sensor comprises an optical waveguide and an electro-optical transducing layer coated on one or more lengths of the optical waveguide.

### BACKGROUND

Provided are systems and methods for measuring electromotive force and, more particularly, methods and systems for formation evaluation and reservoir monitoring that use electromotive force measurements.

A variety of different fiber optic-based electromagnetic reservoir monitoring solutions have been developed for formation evaluation and reservoir monitoring. A number of these fiber optic-based reservoir monitoring solutions include specialized sensor technology and associated applications. For example, methods have been developed for fiber optic electric field, magnetic field, and magnetic induction sensing based on fiber optic strain measurements. In these methods, discrete electromagnetic sensors may be bonded to an optical waveguide and remotely interrogated.

### BRIEF DESCRIPTION OF THE DRAWINGS

These drawings illustrate certain aspects of some examples of the present, and should not be used to limit or define the invention.

FIG. 1 is a schematic diagram of an example electromotive force sensing system.

FIG. 2 is a schematic diagram of an example coated optical waveguide disposed in a tubing encapsulated cable.

FIGS. 3-5 are schematic diagrams illustrating different example arrangements of a coated optical waveguide.

FIG. 6 is schematic diagram of an alternative arrangement for installation of a coated optical waveguide on a casing.

FIGS. 7-10 are schematic diagrams illustrating different example arrangements of electromotive force sensing systems.

FIG. 11 is a chart illustrating conceptual coalbed methane production and resistivity.

FIG. 12 is a schematic diagram illustrating an example earth model for a coalbed methane reservoir.

FIG. 13 is a chart of coal resistivity versus measured electromotive force for the model in FIG. 12.

FIG. 14 is a chart of coal resistivity versus sensitivity for the model in FIG. 12.

### DETAILED DESCRIPTION

Provided are systems and methods for measuring electromotive force and, more particularly, methods and systems for formation evaluation and reservoir monitoring that use electromotive force measurements. The systems and methods may be used as part of an electromagnetic reservoir monitoring system, which may be deployed permanently or temporality on a surface (e.g., seafloor) or downhole in single or multiple wells. The systems and methods may be used in combination with electric and/or electromagnetic sources that can be deployed on a surface (e.g., seafloor) or downhole in single or multiple wells.

The systems and methods may utilize an optical waveguide having one or more lengths coated with an electro-optical transducing layer to become the electromagnetic sensor. An electromagnetic field may be generated in the formation that then may be sensed along the length of the coated optical waveguide. Discrete intervals of the coated optical waveguide may be remotely interrogated, which may be remotely interrogated, for example, using Sagnac interferometry. The interrogation may measure the electromotive force at different points along a length of the coated optical waveguide and not directly measure the electromagnetic field.

A well monitoring system may be provided. Without limitation, a well monitoring system will now be described. The well monitoring system may comprise a power supply that generates an electromagnetic field in a subterranean formation. The well monitoring system may comprise a distributed electromotive force sensor for measuring electromotive force at one or more points along a length of the distributed electromotive sensor. The distributed electromotive force sensor may comprise an optical waveguide and an electro-optical transducing layer coated on one or more lengths of the optical waveguide. The distributed electromotive force sensor may be installed in a wellbore. The distributed electromotive force sensor may be installed on a seafloor. The optical waveguide may be spiraled about a casing installed in a wellbore. The distributed electromotive force sensor may be disposed in an interior of a casing installed in a wellbore. The distributed electromotive force sensor may be coupled to an exterior surface of a casing installed in a wellbore. The distributed electromotive force sensor may be disposed in a fiber optic cable that comprises a bundle of optical waveguides. The electro-optical transducing layer may comprise a material selected from the group consisting of a piezoelectric material, an electrostrictive material, and a combination thereof. The electro-optical transducing layer may comprise an electro-optical transducing material and a polymer. A length of the optical waveguide coated with the electro-optical transducing layer may range from 1 meter to 10,000 meters. The optical waveguide may be periodically coated with the electro-optical transducing layer to have spaced electro-optical transducing layers that each individually have a length of from 1 meter to 1,000 meters and a spacing of from 1 meter to 1,000 meters. The optical waveguide is coated with a material between the spaced electro-optical transducing layers, wherein the material does not bond to the electro-optical transducing layer. The system may further comprise a computer system for monitoring the measured electromotive force.

A method for well monitoring may be provided. Without limitation, the method for well monitoring will now be described. The method may comprise generating an electromagnetic field in a subterranean formation. The method may further comprise measuring an electromotive force at one or more points along a distributed electromotive sensor. The distributed electromotive force sensor may comprise an optical waveguide and an electro-optical transducing layer coated on one or more lengths of the optical waveguide. The distributed electromotive force sensor may be installed in a wellbore. The distributed electromotive force sensor may be installed on a seafloor. The optical waveguide may be spiraled about a casing installed in a wellbore. The distributed electromotive force sensor may be disposed in an interior of a casing installed in a wellbore. The distributed electromotive force sensor may be coupled to an exterior surface of a casing installed in a wellbore. The distributed electromotive force sensor may be disposed in a fiber optic cable that comprises a bundle of optical waveguides. The electro-optical transducing layer may comprise a material selected from the group consisting of a piezoelectric material, an electrostrictive material, and a combination thereof. The electro-optical transducing layer may comprise an electro-optical transducing material and a polymer. A length of the optical waveguide coated with the electro-optical transducing layer may range from 1 meter to 10,000 meters. The optical waveguide may be periodically coated with the electro-optical transducing layer to have spaced electro-optical transducing layers that each individually have a length of from 1 meter to 1,000 meters and a spacing of from 1 meter to 1,000 meters. The optical waveguide is coated with a material between the spaced electro-optical transducing layers, wherein the material does not bond to the electro-optical transducing layer. Measuring the electromotive force may comprise inducing a strain in the optical waveguide in response to the electromagnetic field. The method may further comprise generating an electromagnetic signal with a wireline tool run into the wellbore; sensing the electromagnetic signal with the distributed electromotive force sensor; and determining the electromotive impulse response of the distributed electromotive force sensor at one or more positions of the wireline tool. The method may further comprise generating an electromagnetic field with a wireline tool run into the wellbore to excite the optical waveguide; and measuring an acoustic signal generated by the optical waveguide in response to the electromagnetic field using acoustic transducers disposed on the wireline tool. The method may further comprise monitoring the measured electromotive force to determine time-lapse fluid substitutions in the subterranean formation. The method may further comprise monitoring the measured electromotive force to determine dewatering of a coalbed methane reservoir.

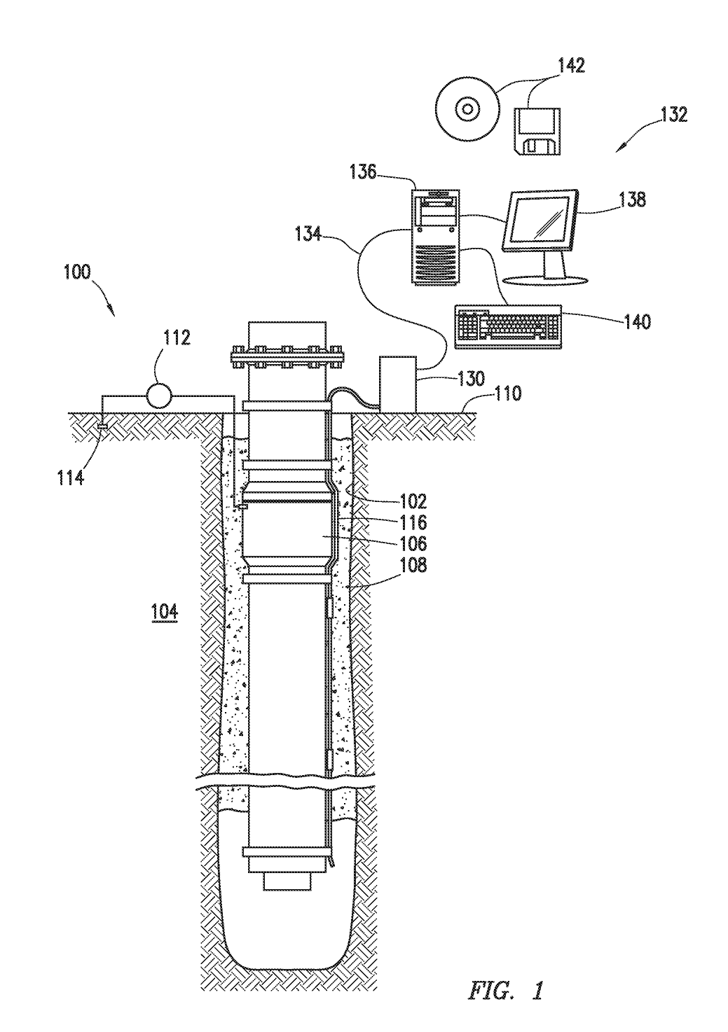

FIG. 1 shows an example well monitoring system 100 for use with a subterranean well. While not illustrated, a drilling rig may be used to drill and complete a well in a typical manner. The drilling system may comprise a drillstring having measurement while drilling (MWD) or logging while drilling (LWD) capability. The illustrative example of FIG. 1 may be used with any of the methods and systems described herein.

As illustrated, a wellbore 102 may extend through the subterranean formation 104. While the wellbore 102 is shown extending generally vertically into the subterranean formation 104, the principles described herein are also applicable to wellbores that extend at an angle through the subterranean formation 104, such as horizontal and deviated wellbores. A casing 106 may be disposed in the wellbore 102. Cement 108 may surround the casing 106 in the wellbore 102. The well may be adapted to guide a desired fluid (e.g., oil and/or gas) from a bottom of the wellbore 102 to a surface 110.

The well monitoring system 100 may comprise a power source 112 for injection of current into the subterranean formation 104 through the casing 106. The power source 112 may be coupled between the casing 106 and a return electrode 114. Because the casing 106 may be an electrically conductive material (e.g., carbon steel), it may act as a source electrode for current flow into the subterranean formation 104 surrounding the wellbore 102. Casing 106 may also be formed from other materials, such as fiberglass, for example, where it is not used to conduct current from the power source 112. The power source 112 may be coupled to the casing 106 at any of a variety of suitable locations, for example, at the wellhead or to the casing 106 in the well bore 102. Multiple connections of the power source 112 to the casing 106 may be made if needed. As illustrated, the return electrode 114 should be placed away from the casing 106 and below the surface 110. The magnitude and distribution of the current flow into the subterranean formation 104 may vary in accordance with the voltage source and the formation's resistivity profile.

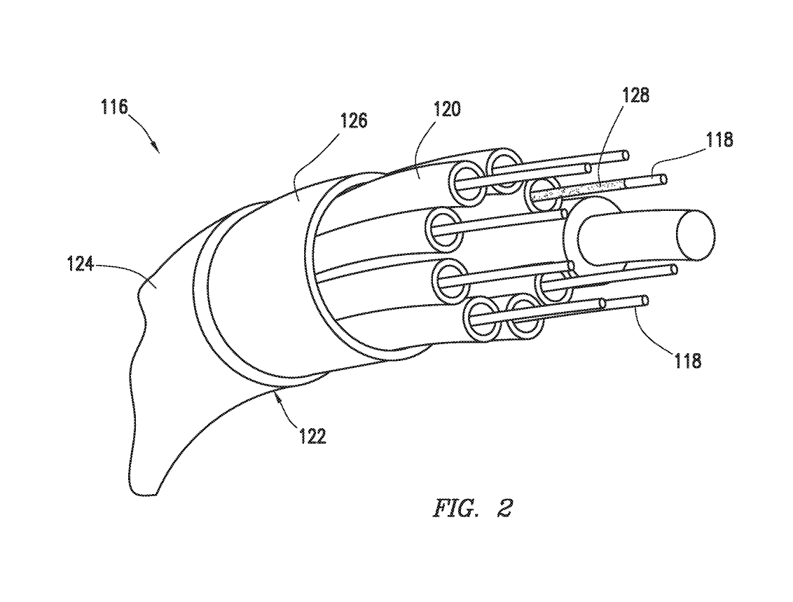

The well monitoring system 100 may further comprise a fiber optic cable 116. As illustrated, the fiber optic cable 116 may be disposed in wellbore 102. For example, the fiber optic cable 116 may be placed along an exterior portion of the casing 106. Alternatively, the fiber optic cable 116 may be disposed in, or coupled to an interior portion of, the casing 106. With additional reference to FIG. 2, an example illustration of the fiber optic cable 116 is shown with a portion cut away so that the interior of the fiber optic cable 116 is illustrated. In FIG. 2, the fiber optic cable 116 may comprise a bundle of optical waveguides 118. The optical waveguides 118 may each be single-mode or multi-mode optical waveguide. Examples of suitable optical waveguides 118 may comprise optical fibers and/or optical ribbons with a silica or plastic core. The optical waveguides 118 may each be disposed in a polymer buffer 120. The polymer buffer 120 may be any suitable polymer buffer for protecting the interior of the optical waveguides 118 from damage, for example, a polyimide and acrylate polymer buffer. As illustrated in FIG. 2, the optical waveguides 118 may be bundled by a jacket 122. The jacket 122 may comprise a single or multiple layers and may also comprise any such material suitable for protecting the optical waveguides 118. Examples of materials may include, but should not be limited to, plastics, metals, etc. In FIG. 2, the jacket 122 may comprise a polymer layer 124 and a metal layer 126. While FIG. 2 illustrates a bundle of optical waveguides 118 in the fiber optic cable 116, other configurations of the fiber optic cable 116 may be employed, such as only a single optical waveguide 118 disposed in the jacket 122.

As illustrated on FIG. 2, at least one of the optical waveguides 118 may be at least partially coated with an electro-optical transducing layer 128. As the electro-optical transducing layer 128 is exposed to a time-varying electromagnetic field, for example, with a component in the direction of the axis of the optical waveguide 118, the electro-optical transducing layer 128 may experience a deformation, such as an expansion or contraction. The mechanical coupling of the electro-optical transducing layer 128 to the optical waveguide 118 should ensure that the deformation in the electro-optical transducing layer 128 may be transferred to the optical waveguide 118, thus modulating light traveling through the optical waveguide 118. The modulated signal may travel along the same optical waveguide 118 or another waveguide to a signal generator/detector 130 (FIG. 1) where the signal may be demodulated and the corresponding perturbation may be determined. This may obviate the need for multiplexing circuitry downhole. The strain induced in the optical waveguide 118 may be proportional to the electromotive force. Variations in the electromotive force with time may be determined. By monitoring these variations, it may be determined if the electromagnetic properties, such as resistivity, of the subterranean formation 104 have changed, for example, due to fluid substitution in the reservoir. Interrogation of the optical waveguide 118 over different lengths coated with the electro-optical transducing layer 128 may allow the optical waveguide 118 to function as distributed sensors to measure electromotive force at different points along the length of the fiber optic cable 116.

The electro-optical transducing layer 128 may comprise any suitable material for inducing a strain in the optical waveguide 118 in response to the electromagnetic field. Examples of suitable materials may include, without limitation, piezoelectric materials and electrostrictive materials. Combinations of suitable materials may also be used. Specific examples of suitable materials may include lead zirconate titanate (PZT), lead magnesium niobate lead nickel niobate, lead manganese niobate, lead antimony stannate, lead zinc niobate, lead titanate, lead magnesium tantalate, lead nickel tantalate, lead titanate doped lead magnesium niobate (PT:PMN), and combinations thereof. The foregoing piezoelectric/electrostrictive materials may be further include an additive of oxide or another type of compound of, for example, lanthanum, barium, niobium, zinc, cerium, cadmium, chromium, cobalt, antimony, iron, yttrium, tantalum, tungsten, nickel, manganese, lithium, strontium, and bismuth. The electro-optical transducing layer 128 may also be a composite that comprises a piezoelectric/electrostrictive material and a polymer. For example, the piezoelectric/electrostrictive material may be dispersed in a polymer matrix. Examples of suitable polymers may include, without limitation, polyvinylidene flouride (PVDF). The composite of the electro-optical transducing layer 128 comprising a composite of the piezoelectric/electrostrictive material and the polymer may provide both functionalities of the electro-optical transducing layer 128 and the polymer buffer 120 so may be used in place of the polymer buffer 120.

Some electrostrictive materials (e.g., PT:PMN) may have relatively low Curie temperatures, e.g., 150° C., which may limit their use in high temperature wells, such as deepwater wells. However, notwithstanding these temperature limits for certain materials, the well monitoring system 100 may still be employed in both offshore and onshore wells. For example, the reservoir temperatures of coal-bed methane target zones in certain regions (e.g., Black Warrior Basin in West Alabama) may typically range from 27° C. to 57° C. Also, the optical waveguide 118 with the electro-optical transducing layer 128 may also be employed on the seafloor, where the temperature may be low, for example, ranging from 0° C. to 30° C., or at the surface 110 where the temperature may be between 0° C. and 60° C.

Any suitable technique may be used for coating the electro-optical transducing layer 128 onto the optical waveguide 118. The homogeneity of bonding between the optical waveguide 118 and the electro-optical transducing layer 128 may ensure electrostriction is accurately transferred to fiber strain. Any temperature differential and gravity strain between the electro-optical transducing layer 128 and the optical waveguide 118 may result in non-uniform stresses, fractures, and even breaks. To limit such damage, the electro-optical transducing layer 128 may have partial or full cuts to release tension during deployment. This may be particularly applicable for gravity-induced strain in free-hanging wireline deployed systems. The electro-optical transducing layer 128 may have a thickness, for example of from about 15 micron to about 60 micron.

Referring again to FIG. 1, the fiber optic cable 116 may be coupled to a signal generator/detector 130 at the surface 110 that can generate a signal to be transmitted downhole. By way of example, the fiber optic cable 116 may terminate at a surface interface with an optical port adapted for coupling fiber(s) (e.g., optical waveguides 118) in the fiber optic cable 116 to a light source and a detector in the signal generator/detector 130. The light source may transmit pulses of light along the fiber optic cable 116. Strain induced along the one or more optical waveguides 118 in the fiber optic cable 116 by the electro-optical transducing layer 128 may modify the light pulses to provide measurements of the electromotive force, for example. The modifications may affect amplitude, phase, or frequency content of the light pulses, enabling the detector to responsively produce an electrical output signal indicative of the receiver measurements. Some systems may employ multiple fibers, in which case an additional light source and detector can be employed for each fiber, or the existing source and detector may be switched periodically between the fibers. The signal generator/detector 130 may employ interrogation techniques to extract and demodulate the strain imposed at different locations along the optical waveguide 118 enabling determination of electromotive force at different locations along the length of the optical waveguide 118. In this manner, for example, resistivity may be mapped along the fiber optic cable 116.

The signal generator/detector 130 may be coupled to a computer system 132 that may be coupled to the signal generator/detector by a control line 134. The computer system 132 may include a central processing unit 136, a monitor 138, an input device 140 (e.g., keyboard, mouse, etc.) as well as computer media 142 (e.g., optical disks, magnetic disks) that can store code representative of the above-described methods. The computer system 132 may be adapted to receive signals from the signal generator/detector 130 representative of the electromotive force measurements. The computer system 132 may act as a data acquisition system and possibly a data processing system that analyzes the electromotive force measurements, for example, to derive subsurface parameters and monitor them over time. The electromotive force measurements received by the computer system 132 may be interpreted in terms of a resistivity model of the subterranean formation 104. The resistivity model in turn may be interpreted in terms of fluids in the formation pores, enabling reservoir fluids to be monitored over time, allowing determination of fluid substitution during waterflooding, and dewatering.

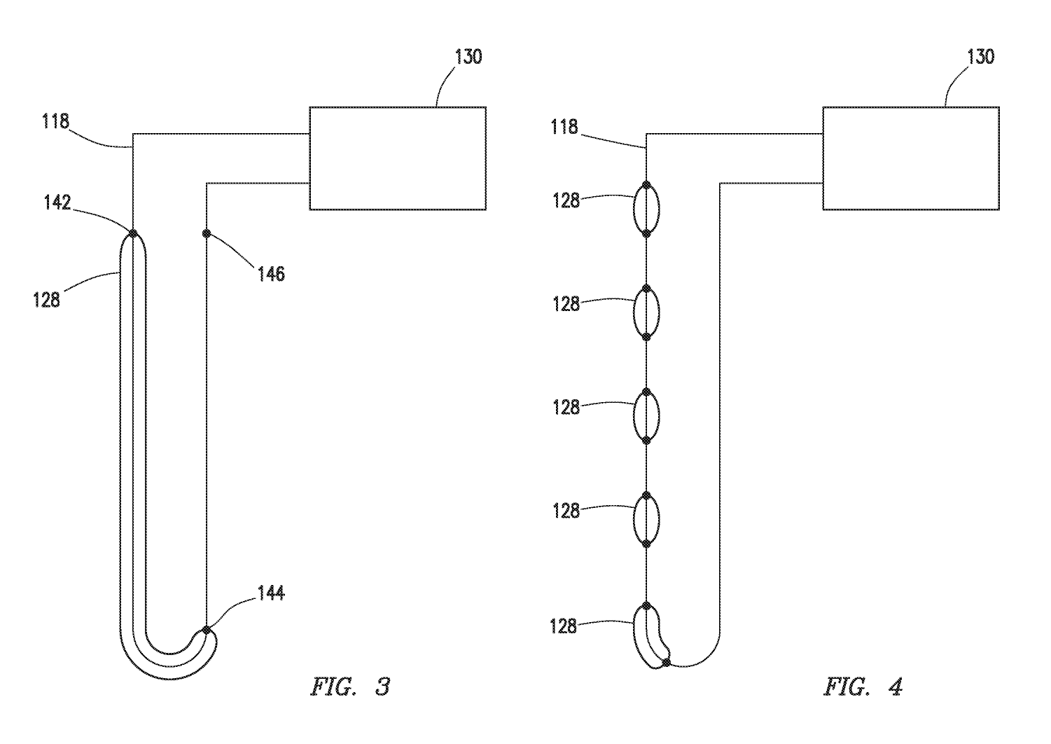

Referring now to FIGS. 3-5, several examples of an optical waveguide 118 at least partially coated with an electro-optical transducing layer 128 are illustrated. In each of these examples, at least one length of the optical waveguide 118 is coated with the electro-optical transducing layer 128. As illustrated, the optical waveguide 118 may form an optical loop and be coupled to a signal generator/detector 130 for interrogation. Any suitable technique of interrogating the optical waveguide 118 for distributed strain measurements may be used, including interrogation techniques that use interferometric methods such as Mach-Zehnder, Michelson, Sagnac, Cabry-Perot, etc. While the interrogation techniques are not described in detail herein, a measured phase shift may be a measure of the induced strain and, thus, a measure of the electromotive force. The optical waveguide 118 may be deployed within a tubing encapsulated cable, such as fiber optic cable 116 of FIG. 1.

In the example of FIG. 3, a length of the optical waveguide 118 may be coated with the electro-optical transducing layer 128 from point 142 to point 144, whereby the optical waveguide 118 from point 146 to point 148 does not include an electro-optical transducing coating. The length of the optical waveguide 118 coated with the electro-optical transducing layer 128 may range from 10 meters to 10,000 meters, alternatively, about 10 meters or longer, about 50 meters or longer, about 100 meters, about 500 meters or longer, about 1,000 meters or longer.

In the example of FIG. 4, the optical waveguide 118 may comprise a plurality of electro-optical transducing layers 128 spaced along the optical waveguide 118. The remainder of the optical waveguide 118 may not include an electro-optical transducing coating. The optical waveguide 118 may need to only be periodically coated as certain portions of the optical waveguide 118 may be disposed in formation(s) that are not of interest. Any suitable technique may be used to prepare an optical waveguide 118 with spaced electro-optical transducing layers 128, including splicing of coated and non-coated optical waveguides to one another to form the optical waveguide 118. The length of the spaced electro-optical transducing layers 128 may range from 1 meter to 1,000 meters with a spacing ranging from 1 meter to 1,000 meters. For example, the electro-optical transducing layers 128 may have a length of about 1 meter with a spacing of about 2 meters. By way of another example, the electro-optical transducing layers 128 may have a length of about 10 meters with a spacing of about 1 meter. The length and spacing of the electro-optical transducing layers 128 may be selected to provide a desired sensitivity for the electromotive force sensing. The optical waveguide 118 may also only be periodically coated with the electro-optical transducing layers 128 to avoid unpredictable stress patterns on the optical waveguide 118.

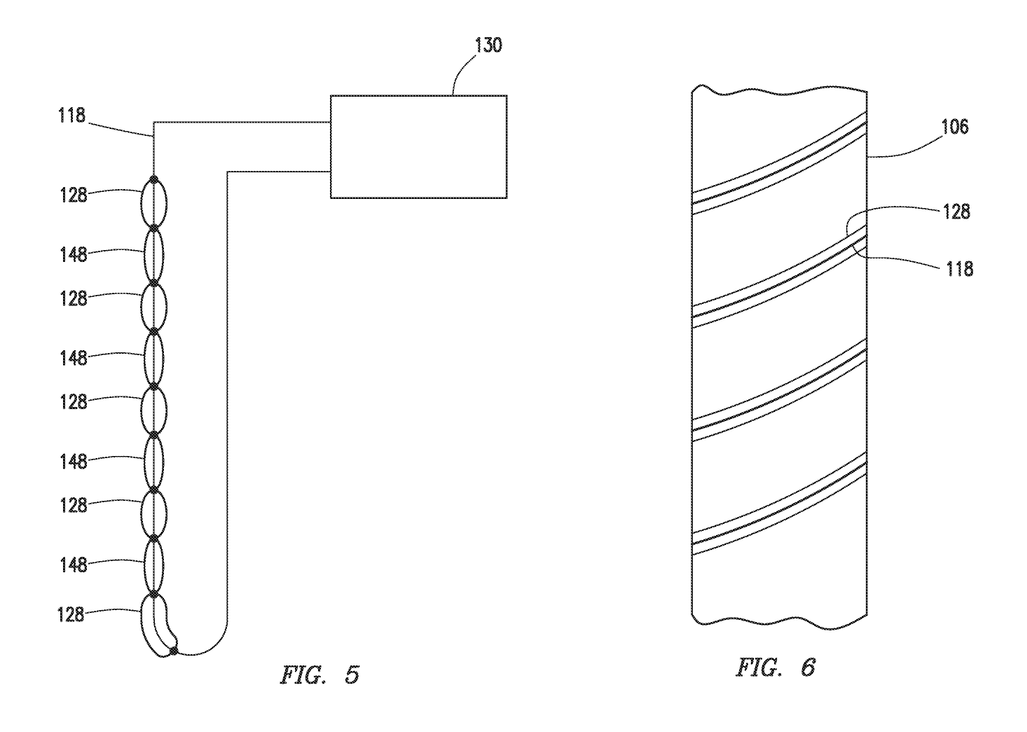

In the example of FIG. 5, the optical waveguide 118 may be periodically coated with a material 148 that does not exhibit electrostriction. Examples of the material 148 may include, without limitation, regular fiber cladding. As illustrated, the material 148 may be spaced along the optical waveguide 118. Accordingly, when the optical waveguide 118 is coated with the electro-optical transducing layers 128, the electro-optical transducing layers 128 only periodically bond to the optical waveguide 118, for example, where the material 148 is not present. The length and spacing of the material 148 may be selected, for example, based on a desired sensitivity to electromotive force sensing.

As previously described, the electro-optical transducing layer(s) 128 on the optical waveguide 118 may be used in the measurement of electromotive force. The electromotive force (V), measured in volts, may be defined as the line integral of the electromagnetic field E along a path I between points a and b along the direction of the axis of the optical waveguide:

V=∫ₐ^{b} Edl (1)

wherein the vectors E and dl are collinear. The convention for a line integral quantity such as the electromotive force is positive reference at the start of the path of integration.

As the electro-optical transducing layers(s) 128 may be exposed to a time-varying electromagnetic field, for example, with a component in the direction of the axis of the optical waveguide 118, the electro-optical transducing layer(s) 128 may deform and, thus, produce a corresponding strain in the optical waveguide.

The electro-optical transducing layer(s) 128 may comprise an electro restrictive material, such as a piezoelectric ceramic, wherein the strain in the optical waveguide 118 may be linearly proportional to the electromotive force:

ε=kV (2)

wherein k is the electrostrictive response parameter for the electro-optical transducing layer(s) 128.

The electro-optical transducing layer(s) 128 may comprise an electro restrictive material, such as an electrostrictive ceramic, wherein the strain in the optical waveguide 118 may be linearly proportional to the square of the electromotive force:

ε=kV² (3)

wherein k is the electrostrictive response parameter for the electro-optical transducing layer(s) 128.

The optical fiber may be excited by a low frequency time-harmonic external electromagnetic field, which induces strain along the direction of the axis of the optical waveguide. By remotely measuring the strain along the direction of the axis of the optical waveguide, and by knowing the functional relation between strain and the low frequency time-harmonic electromotive force V_{Ω} cos Ωt, whether by equations (2) or (3), the electromotive force may be sensed.

A high-frequency carrier voltage V_{ω} cos ωt may be applied across the electro-optical transducing layer(s) 128 while the low-frequency electromotive force V_{Ω} cos Ωt is being sensed. The nonlinear electrostrictive response may cause a mixing of signals such that the low frequency signals at Ω may be upconverted to strains at the sideband frequencies w±Ω. This may have the advantage, allowing the electromotive force to be sensed at higher frequencies where the 1/ƒlow frequency electromagnetic noise (e.g., from telluric currents) may not be dominant, yielding improve signal to noise.

Referring now to FIG. 6, another example arrangement of an optical waveguide 118 at least partially coated with an electro-optical transducing layer(s) 128 is shown. In the example of FIG. 6, the optical waveguide 118 may be spiraled about the casing 106 or other downhole equipment, such as production tubing, tool body, wireline, etc. In general, the systems and methods disclosed herein may have sensitivity along the direction of the optical waveguide 118. However, by spiraling the optical waveguide 118 along the casing 106 as shown in FIG. 6, azimuthal sensitivity may be obtained. As will be appreciated, the optical waveguide 118 may be disposed within a tubing encapsulated cable, such as fiber optic cable 116 shown on FIG. 2, for example.

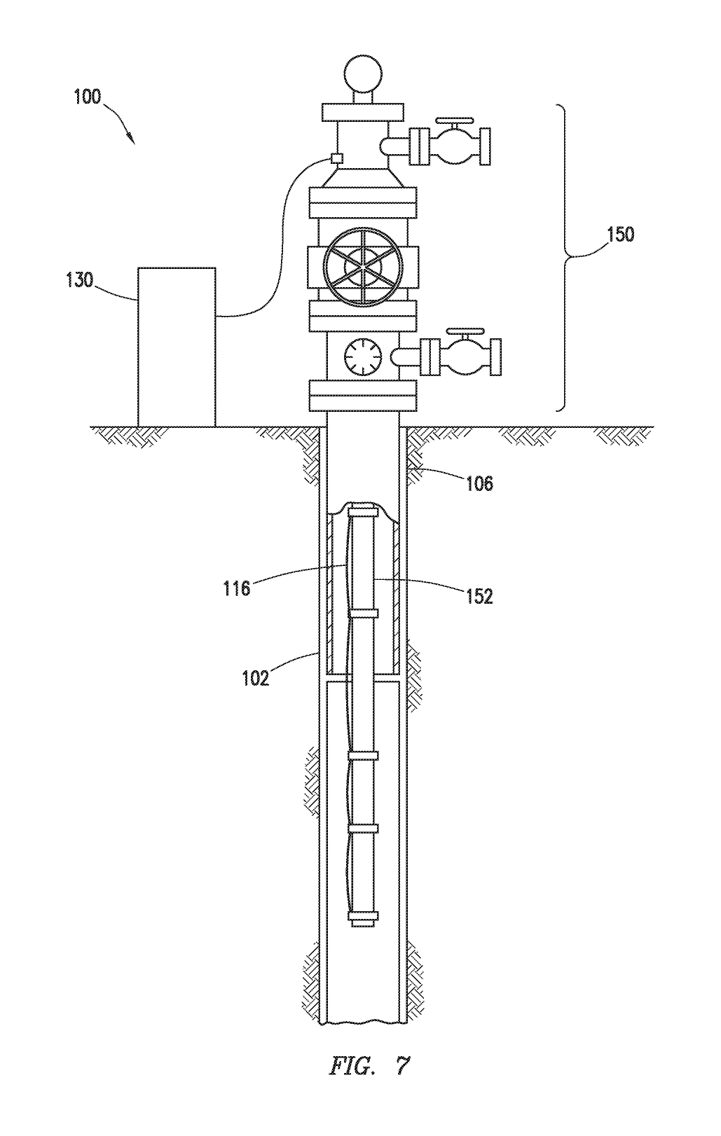

FIG. 7 illustrates another example of a well monitoring system 100 that may be representative of a well being monitored using a fiber optic cable 116, which may contain an optical wave guide 118 at least partially coated with an electro-optical transducing layer(s) 128, as shown on FIGS. 2-5, for example. In the example of FIG. 7, a series of valves 150 may be used to cap the well. Casing 106 may be disposed in the wellbore 102. Production tubing or a wireline 152 may be inserted into the casing 106. The fiber optic cable 116 may be coupled within the casing 106, either by attachment to an internal portion of the casing 106 or to the production tubing or wireline 152. Alternatively, the fiber optic cable 116 may be disposed in, or coupled to an interior portion of, the casing 106. The fiber optic cable 116 may include one or more optical wave guides 118 (e.g., FIGS. 2-5) that function as distributed sensors to measure electromotive force at different points along the length of the fiber optic cable 116. Specific information about the fluids in the subterranean formation 104 may inferred from analysis of the signal from the fiber optic cable 116. Signal generator/detector 130 may be coupled to the fiber optic cable 116 for receiving signals from the fiber optic cable 116.

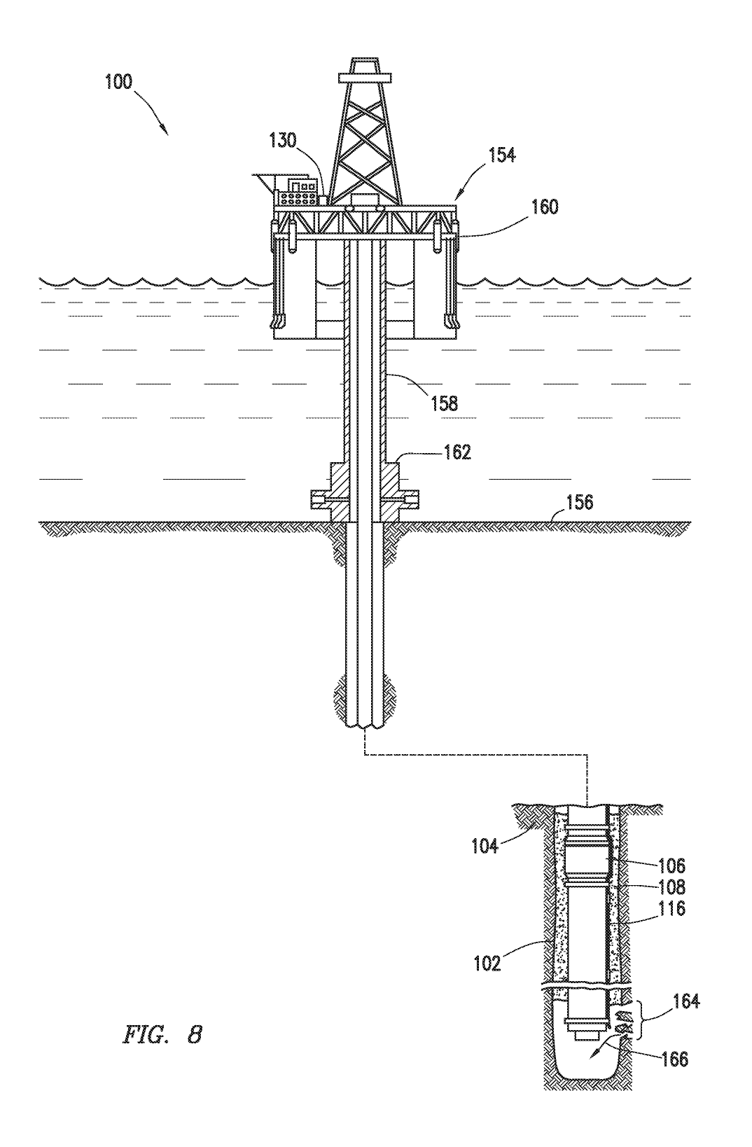

FIG. 8 illustrates an example of a well monitoring system 100 that may be representative of a subsea well to be monitored using a fiber optic cable 116, which may contain an optical wave guide 118 at least partially coated with an electro-optical transducing layer(s) 128, as shown on FIGS. 2-5, for example. In the example of FIG. 8, a semi-submersible platform 154 may disposed above a seafloor 156. A subsea conduit 158 may extend from a deck 160 of the semi-submersible platform 154 to a wellhead installation 162. Beneath the wellhead installation 162, wellbore 102 may penetrate subterranean formation 104. Cement 108 may surround casing 106 in wellbore 102. The well may be adapted to guide a desirable fluid (e.g., oil, gas, etc.) from a bottom of the wellbore 102 to surface of the earth. Perforations 164 may be formed in the wellbore 102 to facilitate the flow of a fluid 166 from the subterranean formation 104 into the wellbore 102 and then to the surface.

As illustrated, the fiber optic cable 116 may be placed along an exterior portion of the casing 106 or along the wellbore 102. Alternatively, the fiber optic cable 116 may be disposed in, or coupled to an interior portion of, the casing 106. The fiber optic cable 116 may include one or more optical wave guides 118 (e.g., FIGS. 2-5) that function as distributed sensors to measure electromotive force at different points along the length of the fiber optic cable 116. Specific information about the subterranean formation 104 of fluids therein may inferred from analysis of the signal from the fiber optic cable 116. Signal generator/detector 130 may be coupled to the fiber optic cable 116 for receiving signals from the fiber optic cable 116.

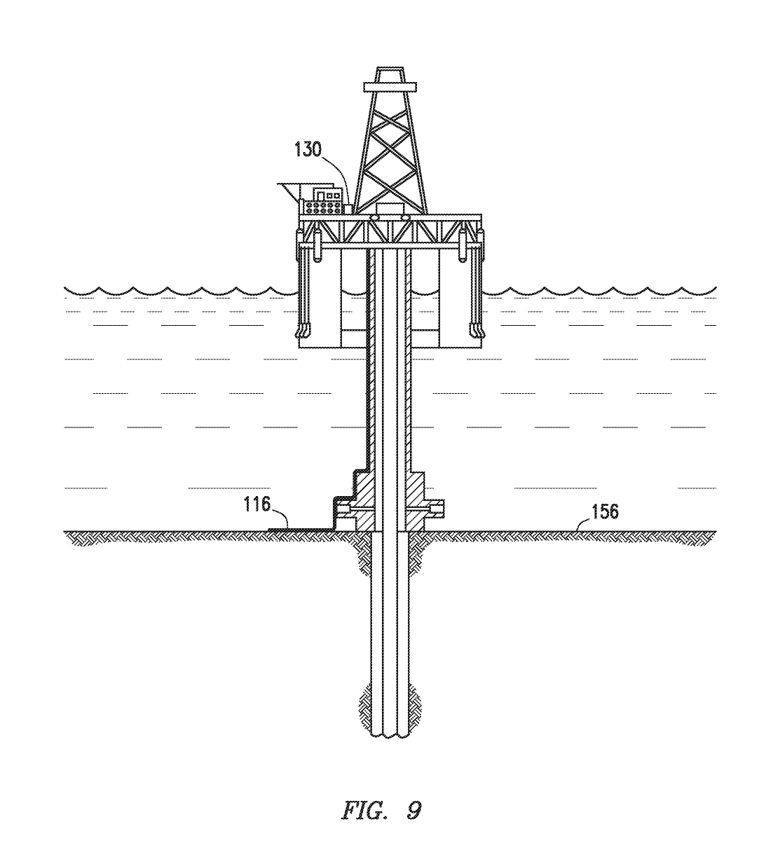

FIG. 9 illustrates an example of a well monitoring system 100 that may be representative of a subsea well to be monitored using a fiber optic cable 116, which may contain an optical wave guide 118 at least partially coated with an electro-optical transducing layer(s) 128, as shown on FIGS. 2-5, for example. In the example of FIG. 8, the optical waveguide 118 may be disposed a surface, such as the seafloor 156. The fiber optic cable 116 may include one or more optical wave guides 118 (e.g., FIGS. 2-5) that function as distributed sensors to measure electromotive force at different points along the length of the fiber optic cable 116. Specific information about the subterranean formation 104 of fluids therein may inferred from analysis of the signal from the fiber optic cable 116. Signal generator/detector 130 may be coupled to the fiber optic cable 116 for receiving signals from the fiber optic cable 116.

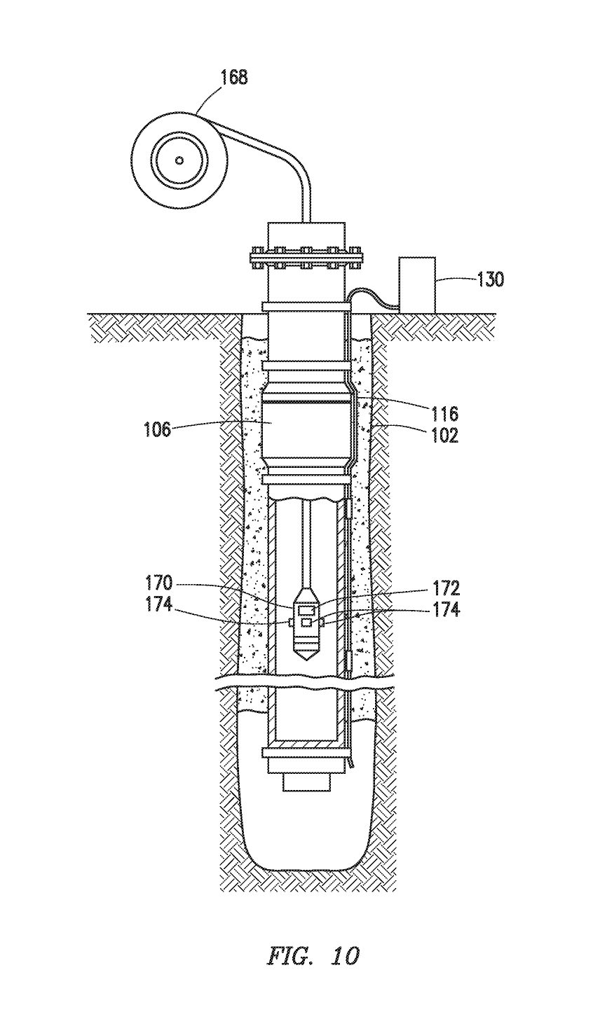

FIG. 10 illustrates an example of a well monitoring system 100 that may be representative of a well to be monitored using a fiber optic cable 116, which may contain an optical wave guide 118 at least partially coated with an electro-optical transducing layer(s) 128, as shown on FIGS. 2-5, for example. In the example of FIG. 10, casing 106 may be disposed in the wellbore 102. The fiber optic cable 116 may be disposed along an exterior portion of the casing 106. Alternatively, the fiber optic cable 116 may be disposed in or coupled to an interior portion of the casing 106. The fiber optic cable 116 may include one or more optical wave guides 118 (e.g., FIGS. 2-5) that function as distributed sensors to measure electromotive force at different points along the length of the fiber optic cable 116. Specific information about the subterranean formation 104 of fluids therein may inferred from analysis of the signal from the fiber optic cable 116. Signal generator/detector 130 may be coupled to the fiber optic cable 116 for receiving signals from the fiber optic cable 116.

As illustrated, hoist 168 may be used to deploy a wireline tool 170 into the wellbore 102. The wireline tool 170 may include a transmitter 172, for example, that may generate an electromagnetic signal, wherein the electromagnetic signal may be sensed by the fiber optic cable 116. The transmitter current waveform may be deconvolved from the measured electromotive force to recover the electromotive impulse response. From a plurality of different wireline tool 170 positions in the wellbore 102, this electromotive impulse response may be used for calibration of electromotive force measurements. Alternatively, the wireline tool 170 may be used to determine the azimuthal position of the fiber optic cable 116, particularly the optical wave guide 118 at least partially coated with an electro-optical transducing layer(s) 128 (e.g., FIGS. 2-5), in the wellbore 102. To determine the azimuthal position, the fiber optic cable 116 may be excited with an electric source and the resulting acoustic signal may be measured with an acoustic sensor. For example, the wireline tool 170 may traverse the wellbore 102 generating an electromagnetic field from the transmitter 172, for example, with an electrode in contact with the casing 106. The induced strain should generate an acoustic signal that could be sensed with an acoustic transducer 174, for example, on the wireline tool 170. Directionality may be obtained by having multiple acoustic transducers 174 azimuthally about the wireline tool 170 body. This may be particularly beneficial for locating the fiber optic cable 116, for example, prior to certain wellbore 102 operations, such as perforating.

For the purposes of illustration, the examples of FIGS. 1 and 7-10 shown a wellbore 102 that is vertically oriented. However, the methods and systems described herein may be used in other wellbore 102 configurations, including a horizontal penetration configuration or an oblique wellbore 102 configuration. Additionally, the examples of FIGS. 1 and 6-10, illustrate different arrangements in which the optical waveguide 118 disclosed herein may be used in well monitoring. It should be understood that the present disclosure should not be limited to any particular technique for placement of the optical waveguide 118 in the well but is intended to encompass use of the optical waveguide 118 in well monitoring, whether placed in the casing 106, outside the casing 106, at a surface (e.g., seafloor 156), etc.

The disclosed examples of electromotive force sensing may be simultaneously deployed with other fiber optic-based sensor systems, including, but not limited, distributed acoustic, temperature, and strain sensing. By way of example, an optical wave guide 118 at least partially coated with an electro-optical transducing layer(s) 128 as disclosed herein may be deployed from the same tubing encapsulated cable, such as fiber optic cable 116 on FIG. 2, as one or more additional fiber optic-based sensor systems. Deployment of the fiber optic-based systems in the same tubing encapsulated cable may provide operational stability, for example, in high pressure environments (e.g., 35,000 psi) while subject to chemical reactivity and continuous vibrations for an extended period of time, as may be encountered on the seafloor and in oilfield wells. The optical waveguides 118 may be multi-modal such that more than one distributed sensing method may be simultaneously interrogated.

In some examples, temperature dependent characteristics of the electro-optical transducing layer(s) 128 may be characterized for calibrating electromotive force measurements. In practice, the temperature or temperature gradient across the interrogating intervals of the electromotive force sensing system may be measured and remotely interrogated from a distributed temperature sensing system.

In additional examples, electromotive force measurements may be corrected for vibration effects by using a distributed acoustic sensing system, such as well monitoring system 100 on FIGS. 1 and 7-10. The cancellation of acoustic and vibration noise may be achieved through the length of the optical waveguide 118 that is not sensitized (e.g., length(s) without an electro-optical transducing layer(s) 128), as long as they are deployed in close proximity to one another. This may be achieved if the fiber optic-based systems are deployed in the same tubing encapsulated cable.

As disclosed herein, the disclosed distributed acoustic sensing systems (e.g., well monitoring system 100 on FIGS. 1 and 7-10) may have no sensor power consumption. This may be particularly beneficial for deployment in subsea environments where the available power from a subsea nodule may be very limited. In some instances, the disclosed optical waveguides 118 may be fabricated to enable efficient mass production and ease of deployment. For example, for permanent electromagnetic reservoir monitoring, the optical waveguides 118 may be pre-fabricated and delivered on a cable drum for ease of deployment.

There may be several potential advantages to the systems and methods disclosed herein, only some of which may be alluded to herein. One of the many potential advantages of the methods and systems may be that distributed sensing of the electromotive force of an electromagnetic field may be provided for reservoir monitoring. Another advantage is that electrodes may not be required for measuring the electromotive force (or electromagnetic field). Yet another advantage the bonding of discrete electromagnetic sensors to the optical waveguide may not be required, thus simplifying system fabrication and deployment, for example, in permanent reservoir monitoring systems.

To facilitate a better understanding of the present claims, the following examples of certain aspects of the disclosure are given. In no way should the following examples be read to limit, or define, the entire scope of the claims.

### EXAMPLES

In the past few years, there has been significant investment in coalbed methane for unconventional gas production in certain regions, such as Australia and the United States. In a coalbed methane reservoir, methane may be stored within coal cleats or dissolved in connate water. The primary mechanism for coalbed methane production may be through Darcy flow through dewatering or depressurizing of coal seams over several months. During dewatering, methane desorbs from the coal and with increased formation permeability, more readily flows to the wellbore.

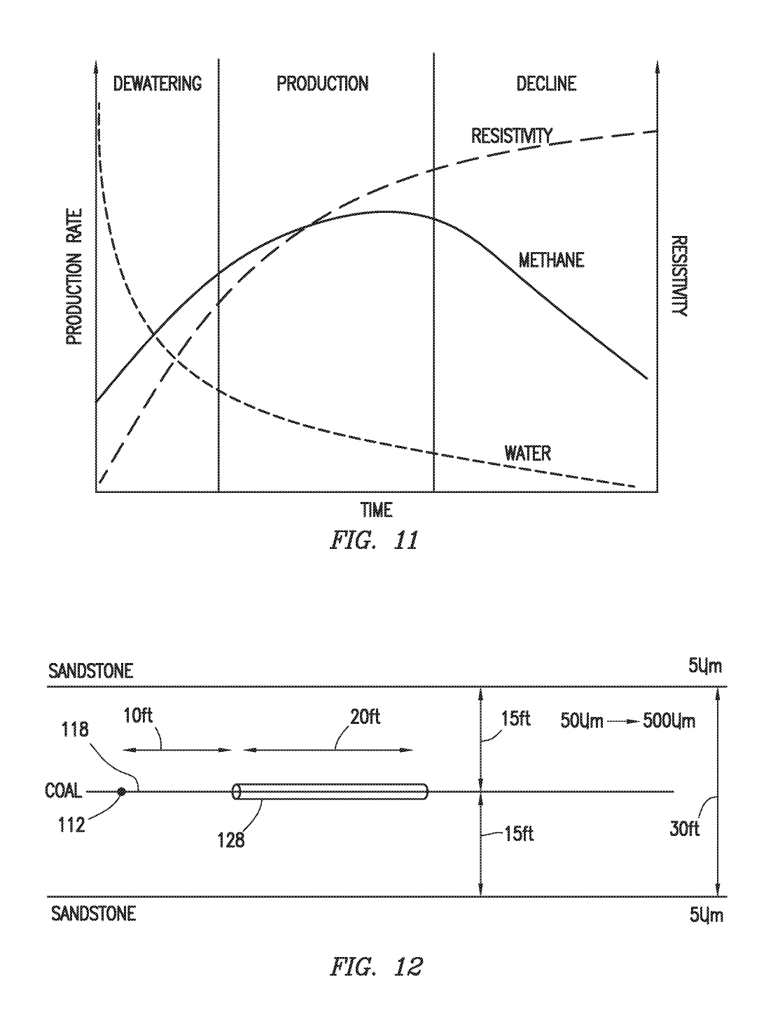

FIG. 11 illustrates a hypothetical model showing coalbed methane production and resistivity over time. As shown in FIG. 11, methane production may be negligible during initial dewatering stages. However, over time, water production may diminish and methane production may increase. Gradually, the coal may be dewatered and degassed. This is typically not accelerated as rapid dewatering may result in reservoir compaction and thus decreased permeability due to overburden pressure. Production may be enhanced by carbon dioxide injection, as carbon dioxide preferentially absorbs onto coal; forcing methane to desorb and diffuse into the cleat system.

From a rock physics perspective, dewatering may be assumed to be a fluid substitution; therefore, resistivity should change. The resistivity of a “wet coal” may be less than 100 ohm-m (depending on the connate water resistivity), whereas the resistivity of “dry coal” may often be greater than 500 ohm-m (e.g., 1000+ ohm-m). Accordingly, electrical resistance tomography may be used for monitoring underground coal gasification.

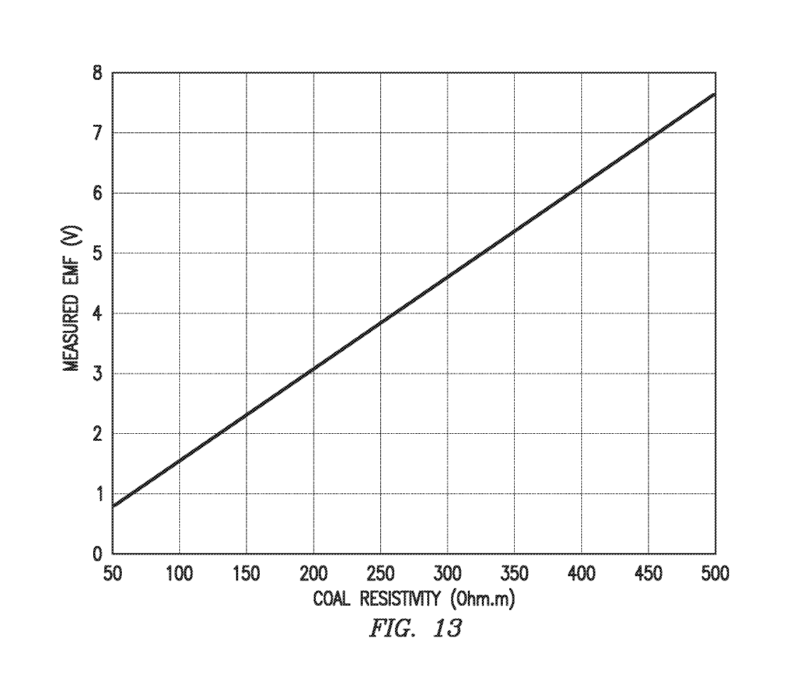

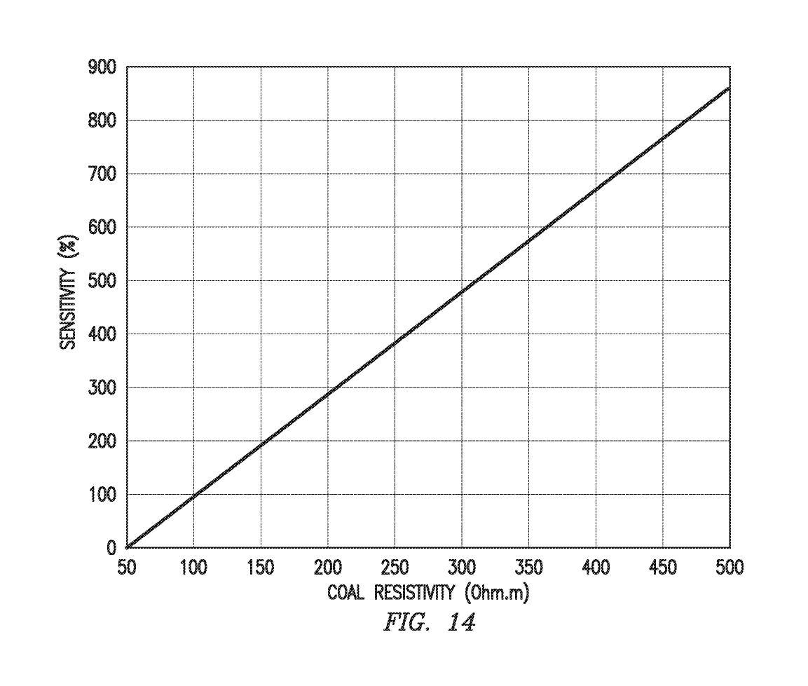

FIG. 12 illustrates a hypothetical earth model of coalbed methane reservoir subject to degasification. As illustrated, the initial reservoir resistivity may be 50 ohm-m and the final reservoir resistivity may be 500 ohm-m. The electromagnetic reservoir monitoring system may comprise a power source 112, which may be an electric monopole transmitter with 1 A current, and a distributed electromotive force sensing system, both deployed from the same well. As illustrated, the distributed electromotive force sensing system may comprise an optical waveguide 118 having a 20-foot length coated with an electro-optical transducing layer 118, wherein the optical waveguide 118 may be interrogated over the 20-foot length. The system may be operated at 1 Hz. FIG. 13 illustrates the electromotive force signal for the 20-foot length of the optical waveguide 118 as would be measured for the model in FIG. 12. The signal level is on the order of V. FIG. 14 illustrates the sensitivity that would be measured over the 20-foot length of the optical waveguide 118 for the model in FIG. 12.

The preceding description provides various embodiments of the systems and methods of use disclosed herein which may contain different method steps and alternative combinations of components. It should be understood that, although individual embodiments may be discussed herein, the present disclosure covers all combinations of the disclosed embodiments, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps.

Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, and may be modified and practiced in different but equivalent manners apparent to those skilled in the art having the benefit of the teachings herein. Although individual embodiments are discussed, the disclosure covers all combinations of all of the embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of those embodiments. If there is any conflict in the usages of a word or term in this specification and one or more patent(s) or other documents that may be incorporated herein by reference, the definitions that are consistent with this specification should be adopted.

What is claimed is:

1. A well monitoring system comprising:
a power supply that generates an electromagnetic field in a subterranean formation; and
a distributed electromotive force sensor for measuring electromotive force at one or more points along a length of the distributed electromotive sensor, wherein the distributed electromotive force sensor comprises an optical waveguide and an electro-optical transducing layer coated on one or more lengths of the optical waveguide. 10

2. The system of claim 1, wherein the distributed electromotive force sensor is installed in a wellbore.

3. The system of claim 1, wherein the distributed electromotive force sensor is installed on a seafloor.

4. The system of claim 1, wherein the optical waveguide is spiraled about a casing installed in a wellbore.

5. The system of claim 1, wherein the distributed electromotive force sensor is disposed in an interior of a casing installed in a wellbore.

6. The system of claim 1, wherein the distributed electromotive force sensor is coupled to an exterior surface of a casing installed in a wellbore.

7. The system of claim 1, wherein the distributed electromotive force sensor is disposed in a fiber optic cable that comprises a bundle of optical waveguides.

8. The system of claim 1, wherein the electro-optical transducing layer comprises a material selected from the group consisting of a piezoelectric material, an electrostrictive material, and a combination thereof.

9. The system of claim 1, wherein the electro-optical transducing layer comprises an electro-optical transducing material and a polymer.

10. The system of claim 1, wherein a length of the optical waveguide coated with the electro-optical transducing layer ranges from 1 meter to 10,000 meters.

11. The system of claim 1, wherein the optical waveguide is periodically coated with the electro-optical transducing layer to have spaced electro-optical transducing layers that each individually have a length of from 1 meter to 1,000 meters and a spacing of from 1 meter to 1,000 meters.

12. The system of claim 11, wherein optical waveguide is coated with a material between the spaced electro-optical transducing layers, wherein the material does not bond to the electro-optical transducing layer.

13. The system of claim 11, further comprising a computer system for monitoring the measured electromotive force.

14. A method for well monitoring comprising:
generating an electromagnetic field in a subterranean formation; and
measuring an electromotive force at one or more points along a distributed electromotive sensor, wherein the distributed electromotive force sensor comprises an optical waveguide and an electro-optical transducing layer coated on one or more lengths of the optical waveguide

15. The method of claim 14, wherein the distributed electromotive sensor is installed in a wellbore.

16. The method of claim 14, wherein the distributed electromotive sensor is installed on a seafloor.

17. The method of claim 14, wherein the distributed electromotive sensor is spiraled around a casing installed in a wellbore.

18. The method of claim 14, wherein measuring the electromotive force comprises inducing a strain in the optical waveguide in response to the electromagnetic field.

19. The method of claim 14, further comprising generating an electromagnetic signal with a wireline tool run into the wellbore; sensing the electromagnetic signal with the distributed electromotive force sensor; and determining the electromotive impulse response of the distributed electromotive force sensor at one or more positions of the wireline tool.

20. The method of claim 14, further comprising generating an electromagnetic field with a wireline tool run into the wellbore to excite the optical waveguide; and measuring an acoustic signal generated by the optical waveguide in response to the electromagnetic field using acoustic transducers disposed on the wireline tool.

21. The method of claim 14, further comprising monitoring the measured electromotive force to determine time-lapse fluid substitutions in the subterranean formation.

22. The method of claim 14, further comprising monitoring the measured electromotive force to determine dewatering of a coalbed methane reservoir.
